(19) United States
(12) Patent Application Publication
(10) Pub. No.: US 2024/0060547 A1
(43) Pub. Date: Feb. 22, 2024

(54) END FITTINGS FOR SYNTHETIC ROPE

(71) Applicant: John E. FRANTA, Grover Beach, CA (US)

(72) Inventor: John E. FRANTA, Grover Beach, CA (US)

(21) Appl. No.: 18/233,825

(22) Filed: Aug. 14, 2023

Related U.S. Application Data
(60) Provisional application No. 63/398,477, filed on Aug. 16, 2022.

(51) Int. Cl. F16G 11/02; B66D 3/04

(52) U.S. Cl. CPC F16G 11/02; B66D 3/04

(57) ABSTRACT

End fittings are shown and described for affixing spliced rope to various styles of fixed fittings. The end fittings shown are optimized for a specific rope diameter to minimize the compressive stresses on the rope while maintaining the inspectability of the rope and the connections. The end fittings are flexible such that they can be utilized with a wide variety of existing fixed fittings making retro fitting easier and more economical.

### CROSS-REFERENCE TO RELATED APPLICATIONS

This application claims the benefit of provisional application No. 63/398,477, filed Aug. 16, 2022, the entire contents of which are incorporated herein by reference for all purposes.

### FIELD OF THE INVENTION

The present version of these embodiments relate generally to the field of end fittings for rigging the masts of sailboats.

### BACKGROUND

These embodiments relate to connections for sailboat rigging, and more particularly to end fittings that have been optimized for use with synthetic rigging.

Sailboats have masts for raising and lowering the sails. The sails catch the wind and provide locomotive power to the sailboat. In order to keep the mast in position, there are stays made from rope, synthetic rope or wire that are affixed between the mast and a fixed position on the sailboat.

For many years, sailboats used rope for stays to hold the mast in a relatively fixed position. Some time after that, sailboats began using wire for stays and this has been the norm for several years. Just recently, some insightful sailors began to use synthetic rope stays to replace the wire stays on a sailboat. This requires some adjustment to the end fittings where the synthetic stays end. The synthetic rope ends cannot be terminated in the same manner as wire stays and hence the need for new end fittings for the ends of synthetic stays.

Synthetic rope should not be loaded in compression as this weakens the joint between the stay and the end fittings and the fixed point on the boat. Also, synthetic rope requires a larger radius end fitting to maintain the appropriate strength in this connection.

There is a fitting at each end of the wire stay. One end of the wire stay typically is affixed to the mast with a mating fitting. The other end of the wire stay is typically affixed to the boat with a mating fitting.

The end fittings that are normally used on the end of the wire stays cannot be used for terminating the synthetic rope as they lessen the strength of this connection. The mating fittings on the mast and on the boat from the wire stays could be used to affix to the end fittings of newly designed synthetic rope fittings provided that they are designed to optimize the performance of the synthetic rope and this connection.

For the foregoing reasons, there is a need for end fittings for sailboat rigging that can utilize the fixed fittings of a wire stay to attach synthetic rope while optimizing the synthetic rope performance or at least minimizing or diminishing any loss in strength of the synthetic rope end fitting connection.

### SUMMARY OF THE INVENTION

In view of the foregoing disadvantages inherent in the art of termination of end fittings for use with synthetic rope, there is a need for an optimized device or design for end fittings.

A first objective of these embodiments is to provide a fitting that optimizes the connection between synthetic rope and an end fitting.

Another objective of these embodiments is to provide a synthetic rope end fitting such that a synthetic rope shroud can replace a wire shroud and utilize the same fixed fittings as the wire shroud.

It is yet another objective of these embodiments to provide an end fitting that can be used to affix to several common fixed fittings used in wire rigging.

It is a still further objective of these embodiments to provide an end fitting that is easy to use by the average user without the use of specialized equipment.

These together with other objectives of these embodiments, along with various features of novelty which characterize these embodiments, are pointed out with particularity in this application forming a part of this disclosure. For a better understanding of these embodiments, the operating advantages and the specific objectives attained by its uses, reference should be had to the accompanying drawings and descriptive matter in which there are illustrated preferred embodiments.

### BRIEF DESCRIPTION OF DRAWINGS

FIG. 1 shows a perspective view of one embodiment of an end fitting.

FIG. 2 shows a front view of the embodiment of FIG. 1.

FIG. 3 shows a rear view of the embodiment of FIG. 1.

FIG. 4 shows a left side view of the embodiment of FIG. 1.

FIG. 5 shows a right side view of the embodiment of FIG. 1.

FIG. 6 shows a bottom end view of the embodiment of FIG. 1.

FIG. 7 shows a top end view of the embodiment of FIG. 1.

FIG. 8 shows a perspective view of another embodiment of an end fitting.

FIG. 9 shows a front view of the embodiment of FIG. 8.

FIG. 10 shows a rear view of the embodiment of FIG. 8.

FIG. 11 shows a left side view of the embodiment of FIG. 8.

FIG. 12 shows a right side view of the embodiment of FIG. 8.

FIG. 13 shows a bottom end view of the embodiment of FIG. 8.

FIG. 14 shows a top end view of the embodiment of FIG. 8.

FIG. 15 shows a perspective view of an additional embodiment of an end fitting.

FIG. 16 shows a front view of the embodiment of FIG. 15.

FIG. 17 shows a rear view of the embodiment of FIG. 15.

FIG. 18 shows a left side view of the embodiment of FIG. 15.

FIG. 19 shows a right side view of the embodiment of FIG. 15.

FIG. 20 shows a bottom end view of the embodiment of FIG. 15.

FIG. 21 shows a top end view of the embodiment of FIG. 15.

FIG. 22 shows a view of one embodiment of an end fitting connecting a rope to a fixed fitting.

FIG. 23 shows a close-up view of one embodiment of an end fitting connecting a rope to a fixed fitting.

FIG. 24 shows a view of one embodiment of an end fitting connected to another type of fixed fitting.

FIG. 25 shows another view of the end fitting and fixed fitting of FIG. 24.

### DETAILED DESCRIPTION

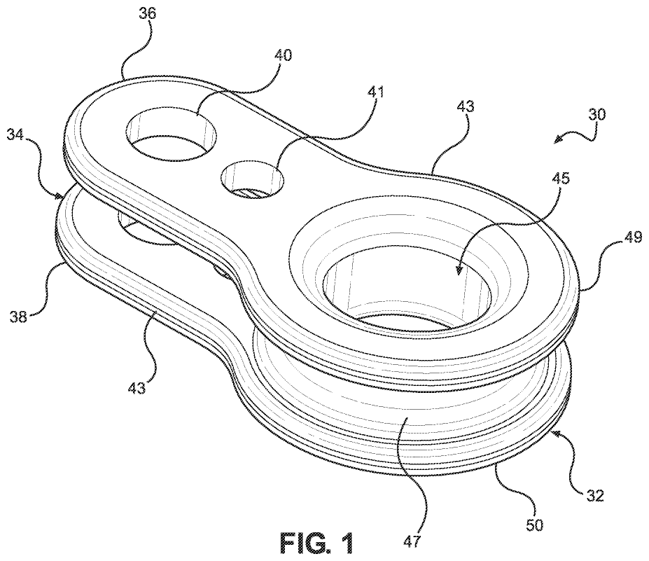

Referring to the drawings in detail wherein like elements are indicated by like numerals, there is shown in FIG. 1 a perspective view of one embodiment of an end fitting 30. This end fitting 30 can be used as a female connection whereby a fixed fitting would be attached between the first and second feet 36 and 38 with a pin located in first through hole 40. As used herein, the phrase “fixed fitting” refers to hardware that is adapted to connect a line, such as wire rigging, to a larger body, such as a sailboat hull or mast, for example. The end fittings of the invention can be adapted to connect to a variety of fixed fittings including, but not necessarily limited to, toggles, turnbuckles, eye bolts, eye nuts, shackles, bow eyes, mast brackets, mast connections, T fittings, stemball connectors, Navtang fittings, mast cranes, mastheads, mast tabs, and the like.

Alternatively, this end fitting 30 could be used as a male type fitting whereby the first foot 36 and second foot 38 could be affixed between opposing sides of a fixed fitting by a pin located in first through hole 40.

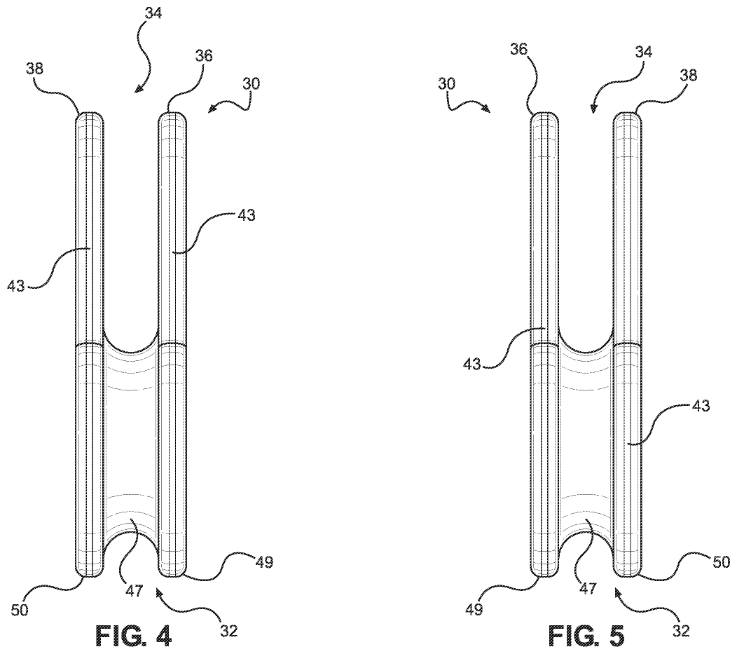

The end fitting has a top end 32 and a bottom end 34. The bottom end 34 has a first foot 36 and a second foot 38, with feet 36 and 38 being spaced apart by a distance. This embodiment shows a first through hole 40 and second through hole 41. These through holes can be made in varying sizes and spaced apart to mate with pre-existing fixed fittings. The end fitting 30 has smooth edges 43 so as to not abrade a rope (not shown) connected to end fitting 30. Located near the top end 32 is a hole 45. The top end 32 is configured such that there is formed a smooth pulley 47 having a concave surface, best seen in FIGS. 4-7. There are raised edges 49 and 50 on both sides of the pulley 47. Pulley 47 is not actually a pulley, but has a pulley like smooth concave surface and does not rotate. The pulleys of the inventive end fittings preferably have a sufficient radius so to maintain the strength of synthetic rope when the rope is connected to the end fitting. In some preferred embodiments, the pulleys, from their outside surface, have a radius that is between about 0.5 inches and about 0.75 inches, about 0.5 inches to about 1 inch, or about 0.5 inches to about 2 inches. In one non-limiting embodiment the pulleys, from their outside surface, have a radius that is about 0.70 inches. In other embodiments, the pulleys are adapted to receive a line having a given diameter, wherein the diameter of the outside surface of the pulleys and the diameter of the line have a ratio that is about 2:1 to about 5:1. This ratio can be about 2:1, about 3:1, about 4:1 or about 5:1. The line diameter for determining the pulley diameter under the ratios disclosed herein can be about 5 mm to about 30 mm. The diameter can be about 5 mm, about 10 mm, about 15 mm, about 20 mm, about 25 mm, or about 30 mm. Without being limited to any particular theory or mechanism, the disclosed ratios reduce tearing force on synthetic ropes when the ropes are connected to the inventive end fittings by the pulleys and placed under tension. As used herein, the term “about” means the value, amount or quantity that is referenced, or that varies (plus or minus) by up to 1%, up to 5%, up to 10% or up to about 20% of the value, amount or quantity that is referenced.

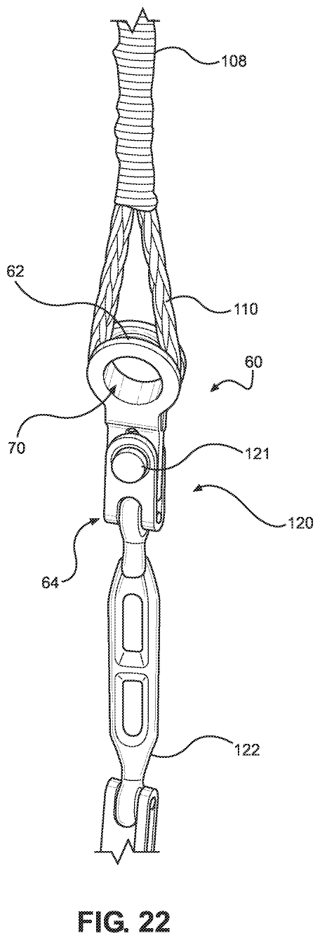

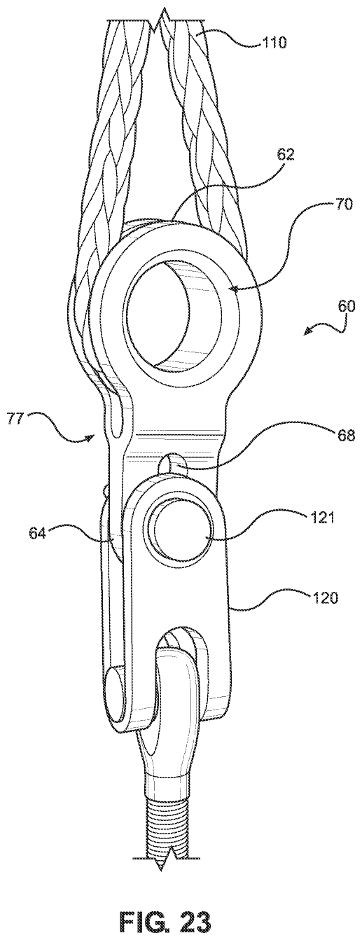

As can be appreciated in FIGS. 22 and 23, if end fitting 60 is used at the bottom end of the rope 110, such as for connecting a stay to the hull of a sailboat, then bottom end 64 would be affixed to the fixed fitting 120 such that references to the top and bottom ends of the inventive end fitting will be maintained. Conversely, if end fitting 60 is affixed to a top end of the rope, such as for connecting a stay to a mast of sailboat, then top end 64 would be oriented downward with bottom end 64 forming the top of the connection to fixed fitting 120. Thus, top ends 32, 62 and 92, and bottom ends 34, 64 and 94, are labeled to indicate the relative positions shown in the drawings and are not indicative of the direction of the inventive end fittings in all locations of a rope connection.

FIG. 22 shows an end fitting 60 and rope 110 with a splice 108 affixing the rope 110 to the end fitting 60. This end fitting 60 is attached to the fixed fitting 120 with a pin 121. This fixed fitting 120 is commonly used with wire systems and in FIG. 22, the wire has been replaced with the rope 110.

FIG. 23 shows a close up of the end fitting 60 coupling rope 110 to fixed fitting 120. Rope 110 is affixed to top end 62 and around pulley 72, while bottom end 64 is affixed to fixed fitting 120 by pin 121 through threaded hole 66. As disclosed herein, threaded hole 66 can be smooth so as to permit the end fitting to affix to fixed fittings by a pin, such as by pin 121 as shown in FIGS. 23-25. The fixed fittings 120 shown in FIGS. 23-25 are commonly used with wire attachments and therefore form types of fixed fittings capable of use with the end fittings of the invention.

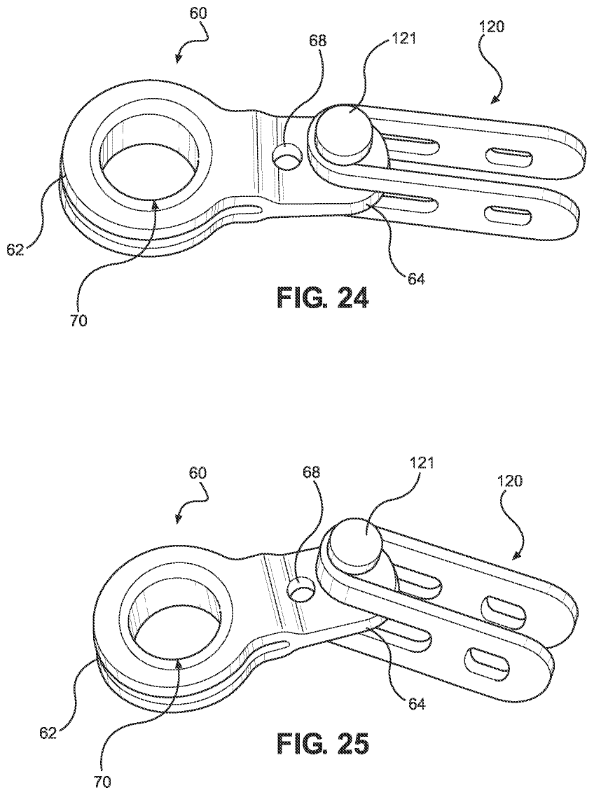

FIG. 24 shows an end fitting 60 affixed to a different fixed fitting 120. It should be understood that the inventive end fittings can be affixed in multiple ways to the existing fixed fittings of a boat that is outfitted for wire rigging. It should also be noted that while for discussion purposes, boat rigging is discussed as an example in this disclosure, it is in no way meant to limit the scope of the use of the inventive devices, or limit their use with synthetic rope or standard rope connections. Synthetic rope can and will continue to be used in other industries and the inventive end fittings can be used to retrofit or replace other connectors with synthetic rope.

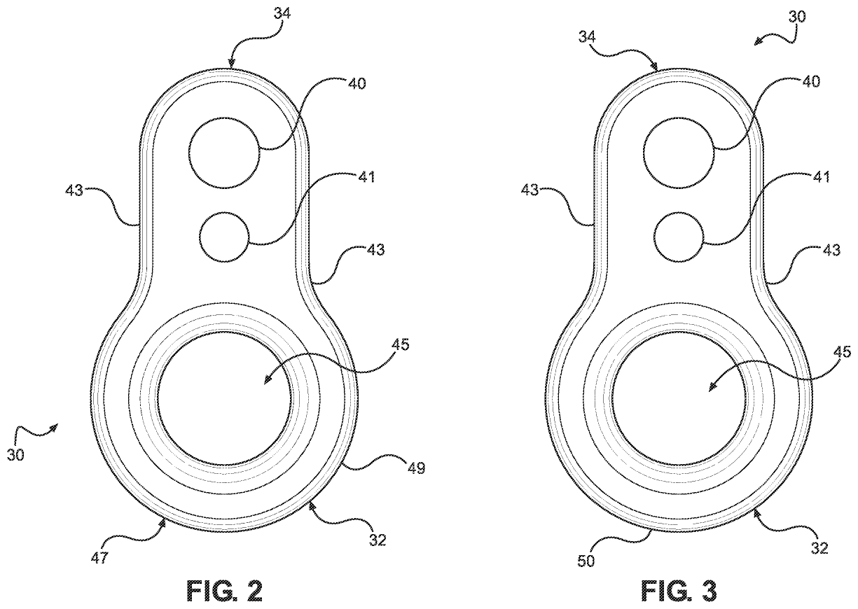

FIG. 2 shows a front view of the end fitting 30 while FIG. 3 shows a back view of the same.

FIG. 4 shows a left side view of the end fitting 30 and FIG. 5 shows a right side view of the end fitting 30. The pulley 47 and its surface can be seen clearly in these views as having a contour and raised edges 49 and 50. This contour and raised edges 49 and 50 are designed for a specific diameter of rope. The radius of the surface of pulley 47 is designed to decrease the compressive stress on the fibers on the inside of the rope loop. The raised edges 49 and 50 are designed to retain the rope 110 in contact with the pulley 47. As the rope diameter increases, so too does the radius of the pulley 47 and the height of raised edges 49 and 50 resulting in an overall increase in the size of the end fitting 30. Without being bound to any particular theory or mechanism, increasing the size of the radius of pulley 47 prevents excessive force from being applied to rope connected to the inventive device when the rope is under load. Thus, the radius of pulley 47 permits the use of synthetic rope as excessive load on the rope is avoided. In some embodiments, the opposing openings of hole 45 are rounded to allow the affixing of other ropes through hole 45 without abrasion as may be needed for specific user applications. The opposing openings of holes 70 and 98 can similarly be rounded.

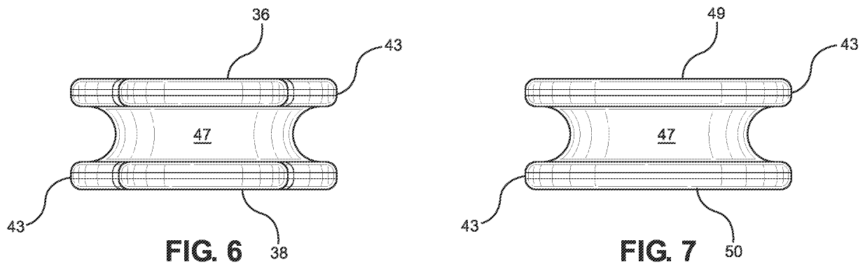

FIG. 6 shows the bottom end view of the end fitting 30 and FIG. 7 shows a top end view of the same. The contour of the pulley 47 and the heights of the raised edges 49 and 50, relative to the surface of pulley 47, can be seen. However, it will be appreciated that the heights of raised edges 49 and 50 can vary and are not necessarily limited to the relative heights shown in the accompanying figures. The smooth contour of the edge 43 is also visible.

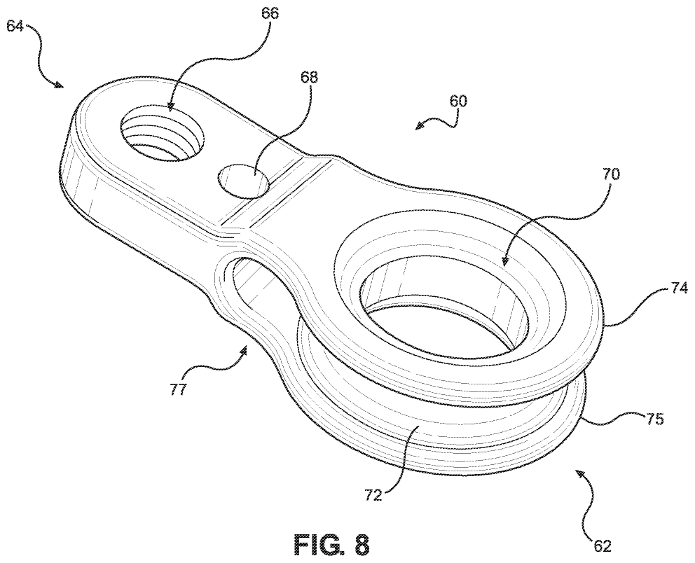

FIG. 8 shows a perspective view of another end fitting 60. This end fitting 60 differs from the previous end fitting 30 in that end fitting 60 includes a male bottom end 64. Male bottom end 64 can be solid. This bottom end 64 can have a threaded hole 66. This bottom end 64 can be received within a fixed fitting (not shown) whereby a bolt (not shown) can be threaded through opposing sides of the fixed fitting and into the threaded hole 66 thereby affixing end fitting 60 to the fixed fitting. While threaded hole 66 is shown with threads, it will be appreciated that threaded hole 66 can be smooth and omit threads so as to permit end fitting 60 to be affixed to fixed fittings by, for example, a pin. Opposing male bottom end 64 is top end 62.

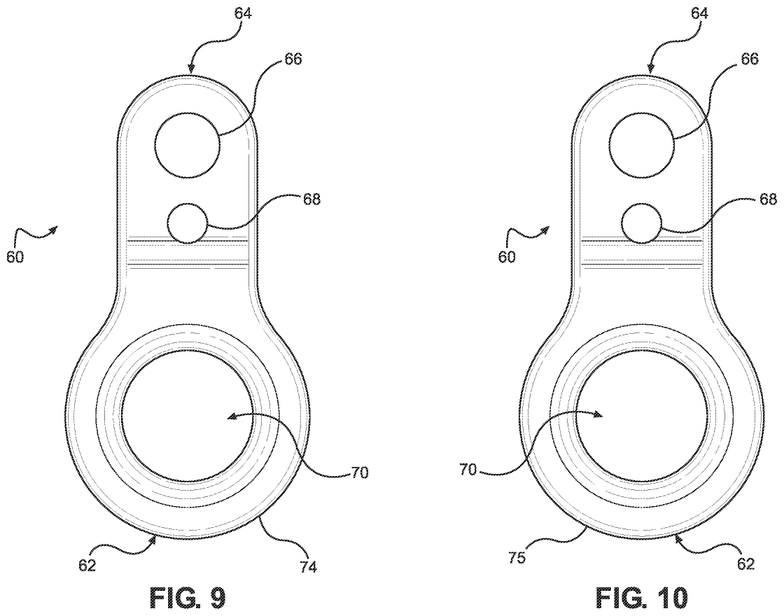

FIGS. 9 and 10 show a front and rear view of end fitting 60. This end fitting 60 has a tapered hole 70, raised edges 74 and 75 and through hole 68.

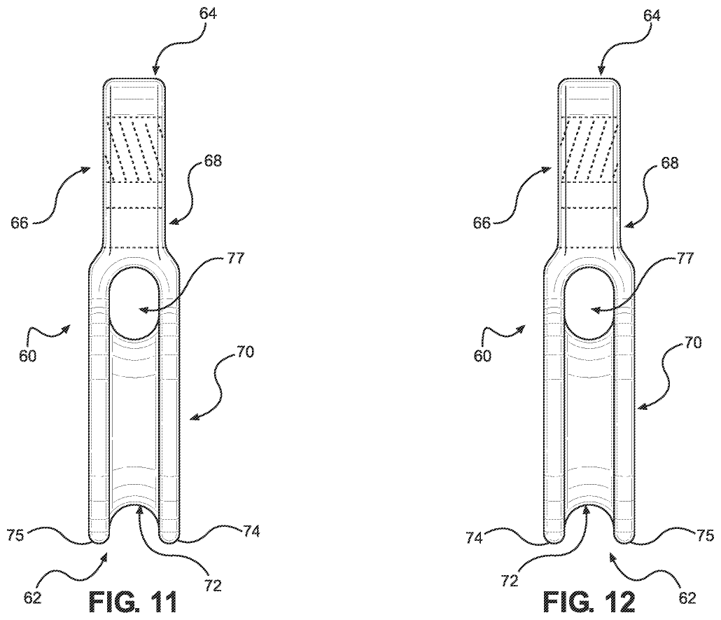

FIGS. 11 and 12 show a left and right side view of end fitting 60. This embodiment has a loop hole 77 which is adapted to receive a rope so as to permit the rope to loop around the pulley 72, such as shown in FIG. 23.

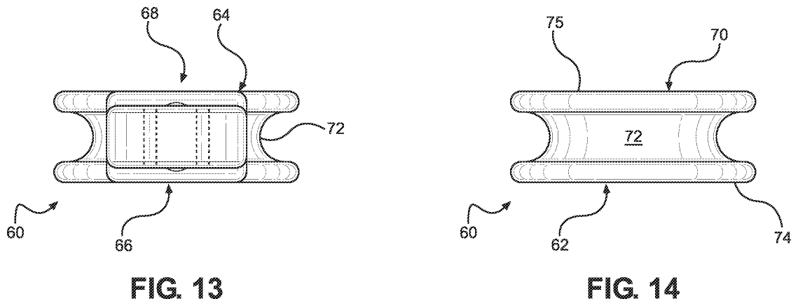

FIGS. 13 and 14 show a bottom end view and a top end view, respectively, of end fitting 60.

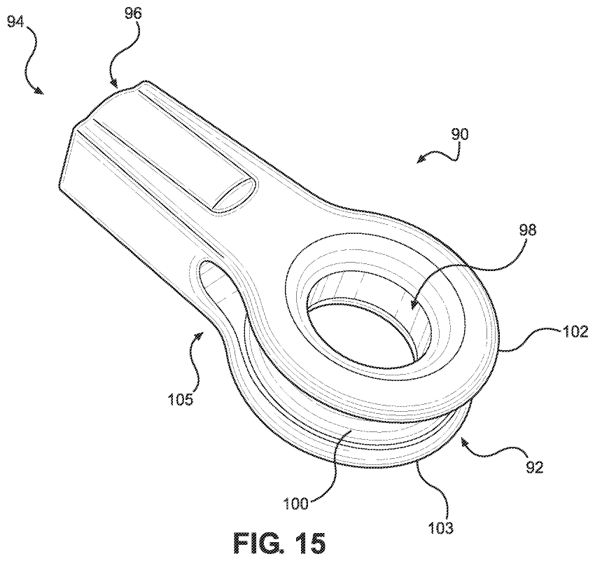

FIG. 15 shows a perspective view of another end fitting 90. This embodiment differs from the previous embodiments in that there is a threaded hole 96 in the bottom end 94. The longitudinal axis of threaded hole 96 can be colinear with, or parallel to, the longitudinal axis of end fitting 90. That is, threaded hole 96 can be centered or offset on bottom end 94. The top end 92 is similar to the previous embodiments shown and includes a pulley 100, raised edges 102 and 103 and tapered hole 98. This embodiment also includes a loop hole 105. This embodiment can be used on fixed fittings that have a threaded rod which would be engaged into the threaded hole 96.

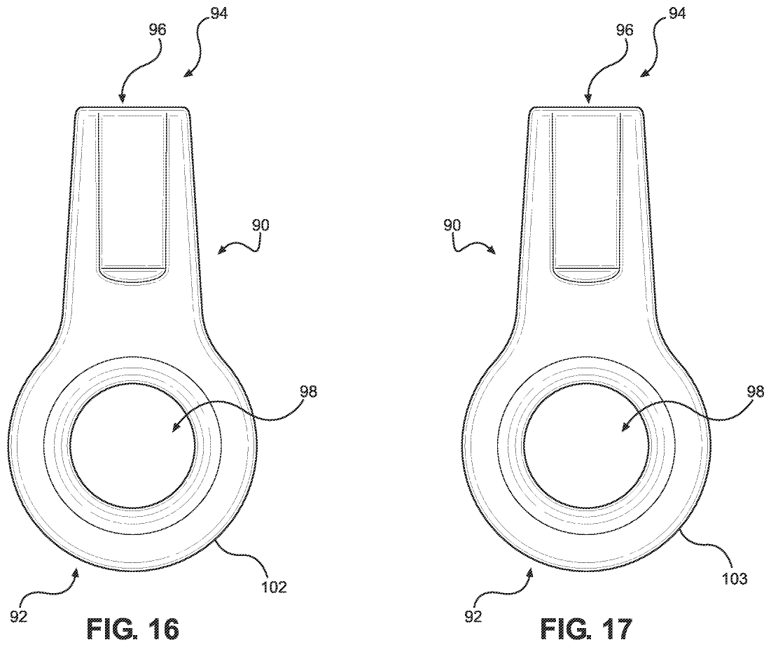

FIGS. 16 and 17 show a front and rear view of end fitting 90. This embodiment has a tapered hole 98 and raised edges 102 and 103.

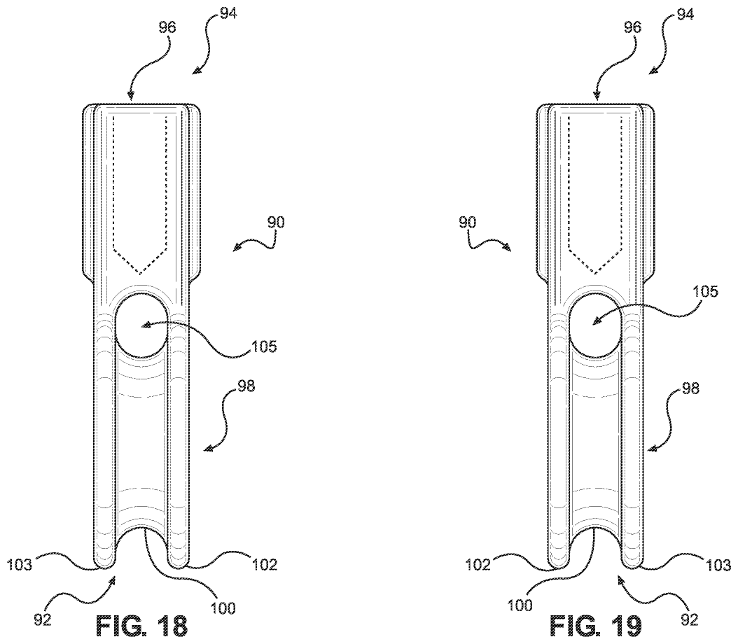

FIGS. 18 and 19 show a left side and right side view of end fitting 90. This view shows the loop hole 105, tapered pulley 100 and raised edges 102 and 103.

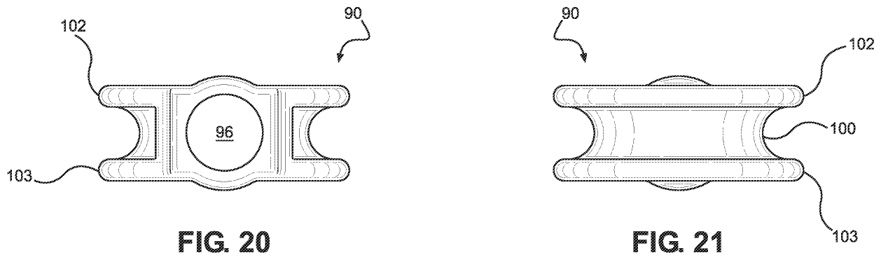

FIGS. 20 and 21 show a bottom end view and top end view, respectively, of end fitting 90.

FIG. 22 shows end fitting 60 affixed to rope 110 by a splice 108, while bottom end 64 is affixed to one type of fixed fitting 120 by a pin 121. The fixed fitting 120 is fixed to a boat connection means 122 in this figure.

FIG. 23 shows an end fitting 60 attached to a rope 110 where the rope loops through the loop hole 77.

FIG. 24 shows an end fitting 60 attached to an alternative fixed fitting 120 by pin 121 through hole 66. FIG. 25 shows another view of end fitting 60 affixed to fixed fitting 120 from FIG. 24, wherein the fixed fitting 120 is partially rotated with respect to end fitting 60.

In some embodiments, the invention provides a method of coupling a rope to a fixed fitting. The method can be practiced by providing end fitting 30, 60, 90 as disclosed herein. Bottom end 34, 64, 94 of the end fitting is then affixed to a fixed fitting. With the use of end fitting 30 or 60, the end fitting can be affixed to the fixed fitting by use of a pin or threaded bolt through hole 40 or 66. With the use of end fitting 90, the end fitting can be affixed to the fixed fitting by threading the fixed fitting into threaded hole 96. A rope is then coupled to top end 32, 62, 92 by wrapping the rope around pulley 47, 72, 100 such that the rope occupies space between the raised edges of the pulley. With the use of end fitting 60, 90, the rope is threaded through loop hole 77, 105. The rope can then be placed under load and secured to another object such as a cleat (e.g., clamcleat), or to itself, such as by a splice, for example. In sailing applications, the fixed fitting to which the inventive end fitting connects can be attached to objects such as masts, mastheads, mast cranes and chainplates. In some embodiments of the method, the inventive end fittings are coupled to synthetic rope.

While the present disclosure describes retro fitting sailboat rigging, it should be understood that the inventive end fittings can be used in any application where ropes are needed to be attached to an object. Thus, the present disclosure is not meant to be limited to sailboat rigging or any specific type of synthetic rope. It will now be apparent to those skilled in the art that other embodiments, improvements, details and uses can be made consistent with the letter and spirit of the foregoing disclosure and within the scope of this application.

1. An end fitting for connecting a rope to a fixed fitting, comprising:
a) a body having a top end and a bottom end;
b) the bottom end being adapted to affix the body to a fixed fitting; and
c) a pulley adapted to affix the body to a rope, wherein (i) the pulley circumscribes the top end of the body, and (ii) at least a portion of the pulley includes a pair of opposing raised edges;
wherein the pulley is adapted to receive a rope between the opposing raised edges.

2. The end fitting of claim 1, wherein the bottom end is adapted to affix the body to a fixed fitting selected from one or more of toggles, turnbuckles, eye bolts, eye nuts, shackles, bow eyes, mast brackets, mast connections, T fittings, stemball connectors, Navtang fittings, mast cranes, mastheads and mast tabs.

3. The end fitting of claim 1, wherein the bottom end is adapted to affix the body to a fixed fitting by at least one through hole.

4. The end fitting of claim 1, wherein the at least one through hole is threaded or smooth.

5. The end fitting of claim 3, wherein the bottom end is solid.

6. The end fitting of claim 5, wherein the top end comprises a loop hole that is adapted to receive a rope and is colinear with the opposing raised edges.

7. The end fitting of claim 3, wherein the bottom end is adapted to affix the body to a fixed fitting by a pair of opposing feet.

8. The end fitting of claim 1, wherein the bottom end is adapted to affix the body to a fixed fitting by threaded hole that is colinear with, or parallel to, a longitudinal axis of the body.

9. The end fitting of claim 1, wherein the top end includes a through hole that is adapted to receive a rope, wherein the through hole is circumscribed by the pulley.

10. The end fitting of claim 9, wherein the through hole includes a pair of rounded openings on opposing sides of the body.

11. The end fitting of claim 1, wherein the body is affixed to (a) a rope by the top end, and (b) a fixed fitting by the bottom end.

12. The end fitting of claim 11, wherein the fixed fitting is affixed to a watercraft.

13. The end fitting of claim 12, wherein the watercraft is a sailboat.

14. The end fitting of claim 13, wherein the rope is affixed to at least one of a sailboat hull and a sailboat mast.

15. The end fitting of claim 11, wherein the rope is synthetic.

16. A method of affixing a rope to a fixed fitting, comprising:
providing an end fitting according to claim 1;
affixing the top end of the body to a rope; and
affixing the bottom end of the body to a fixed fitting.

17. The method of claim 16, wherein the fixed fitting is affixed to a watercraft.

18. The method of claim 17, wherein the watercraft is a sailboat.

19. The method of claim 18, wherein the rope is affixed to at least one of a sailboat hull and a sailboat mast.

20. The method of claim 16, wherein the rope is synthetic.
